(19) United States
(12) Patent Application Publication
(10) Pub. No.: US 2019/0221910 A1
(43) Pub. Date: Jul. 18, 2019

(54) APPARATUS FORMING A PHASE SHIFTER AND AN ANTENNA

(71) Applicant: NOKIA SHANGHAI BELL CO., LTD., Shanghai (CN)

(72) Inventor: Jean-Pierre HAREL, Lannion (FR)

(21) Appl. No.: 16/306,632

(22) PCT Filed: May 15, 2017
(86) PCT No.: PCT/IB2017/052852

§ 371 Date: Dec. 3, 2018

(30) Foreign Application Priority Data
Jun. 3, 2016 (EP) 16305649.2

(51) Int. Cl. H01P 1/18; H01Q 1/50; H01P 3/08; H01Q 1/48; H01P 11/00

(52) U.S. Cl. CPC H01P 1/184; H01Q 1/50; H01P 11/003; H01Q 1/48; H01P 3/08

(57) ABSTRACT

Apparatus forming a phase-shifter is described. The apparatus comprises a strip line and a moving dielectric part. The moving dielectric part surrounds the strip line and is adapted to move only along a longitudinal axis of the strip line. Within this apparatus the size of the area of the strip line surrounded by the moving dielectric part is modified when the moving dielectric part moves along the longitudinal axis.

### FIELD OF INVENTION

The present subject matter relates to phase shifter and more specifically to electro-mechanical phase shifter. This phase shifter can be used within mobile radio antennas, but also to any Radio Frequency (RF) device requiring a phase shift

### BACKGROUND

The technical key requirements of Base Station antennas for radio communication applications are high gain, good purity of horizontal-plane (H-plane) and vertical-plane (V-plane) patterns. Gain and vertical-plane patterns requirements (i.e. tilt value, control of lobes, capability of null filled) are mainly function of the antenna length and are controlled via the feeding network of the antenna.

Variable Electrical Tilt (VET) antennas have capability of tilt variation, i.e. of main lobe position variation versus the horizon. The adjustment of this tilt position may be achieved per several techniques applied to the antenna feeding network, using active and/or passive devices. The main component needed to achieve such tilt variation is a phase shifter device.

The present application deals with passive phase shifter devices, particularly the family of phase shifters using dielectric materials. At least two “dielectric materials” have to be considered with such technique: a solid device (so-called the “phase shifter”) and air (or vacuum). Displacing the solid dielectric material over a propagation line so replacing the air dielectric—creates a phase variation.

The antenna phase shifted feeding network type used today may comprise several dielectric parts, called phase shifters, these parts may sliding under a stripline, or over a microstrip line, as described within the patent application US2004/0080380 and the patent U.S. Pat. No. 6,816,668.

Considering that with such implementation, each radiating element of the panel antenna is potentially unitary phase shifted, the resulting performances of such antenna is very good in terms of performances and stability considering the radiating Electrical cut plane.

The phase shifter of the state of the art comprises the fowling drawbacks:
This construction requires that the dielectric phase shifter parts must slide transversally, while the central actuator is mechanically moved within the axe of the antenna. This implies the use of specific mechanical parts that will realize the axial-to-transversal mechanical efforts transmissions. These parts have a non-negligible cost, and moreover are source of additional frictions, increase backslashes and other mechanical malfunctions created by the multiplication of parts and associated tolerances. These drawbacks are particularly unwanted considering high frequency systems, such as LTE and over.
The standard unitary dielectric phase shifters design permit to achieve phase shift ranges of about ˜60° (i.e. for one dielectric device), resulting for the entire phase shifted feeding network the capability to achieve for the antenna a tilt variation of about 10°. Performing higher phase shift ranges such as 100 or 120° is feasible—permitting to reach a 15° antenna tilt range for example—but at either cost of a wider mechanical dielectric part, or/and, the use of a bigger dielectric value. For high frequency scope, as wavelengths are reduced, increasing dimensions isn't a valid option, and, increasing the dielectric value will impose a higher sensitivity regarding the dielectric part positioning and tolerances.
If the Electrical plane patterns are good in terms of value and stability, it is nevertheless difficult to achieve stable Side Lobes Suppression over −20 dBc versus the antenna main beam.

The proposed electro-mechanical phase shifter reduces the three above mentioned drawbacks and able to deeply reduce the general radio frequency and mechanical constraints related to present Phase Shifter devices, and particularly regarding high frequency bands such as 3.5 GHz and over.

### SUMMARY

Various embodiments propose phase-shifters that can solve the previously described problems. More specifically, some embodiments provide a phase-shifter.

This summary is provided to introduce concepts related to examples of phase-shifter.

In one implementation, an apparatus forming a phase-shifter is described. The apparatus comprises a strip line and a moving dielectric part. The moving dielectric part surrounds the strip line and is adapted to move only along a longitudinal axis of the strip line. Within this apparatus the size of the area of the strip line surrounded by the moving dielectric part is modified when the moving dielectric part moves along the longitudinal axis.

In one implementation, an antenna is described. The antenna comprises an apparatus forming a phase shifter and the apparatus is placed in a housing of which one of the faces is formed by a chassis of the antenna.

### BRIEF DESCRIPTION OF THE FIGURES

The detailed description is given with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 presents a phase-shifter.

FIG. 2 presents a phase-shifter.

FIGS. 3-a to 3-c present a phase-shifter.

FIG. 4 presents a phase-shifter.

FIGS. 5-a to 5-f present examples of other phase shifters impedance transformer designs.

FIGS. 6-a to 6-c presents a phase-shifter at different positions.

The FIGS. 7-a and 7-b present another embodiment of the phase shifter.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

### DESCRIPTION OF EMBODIMENTS

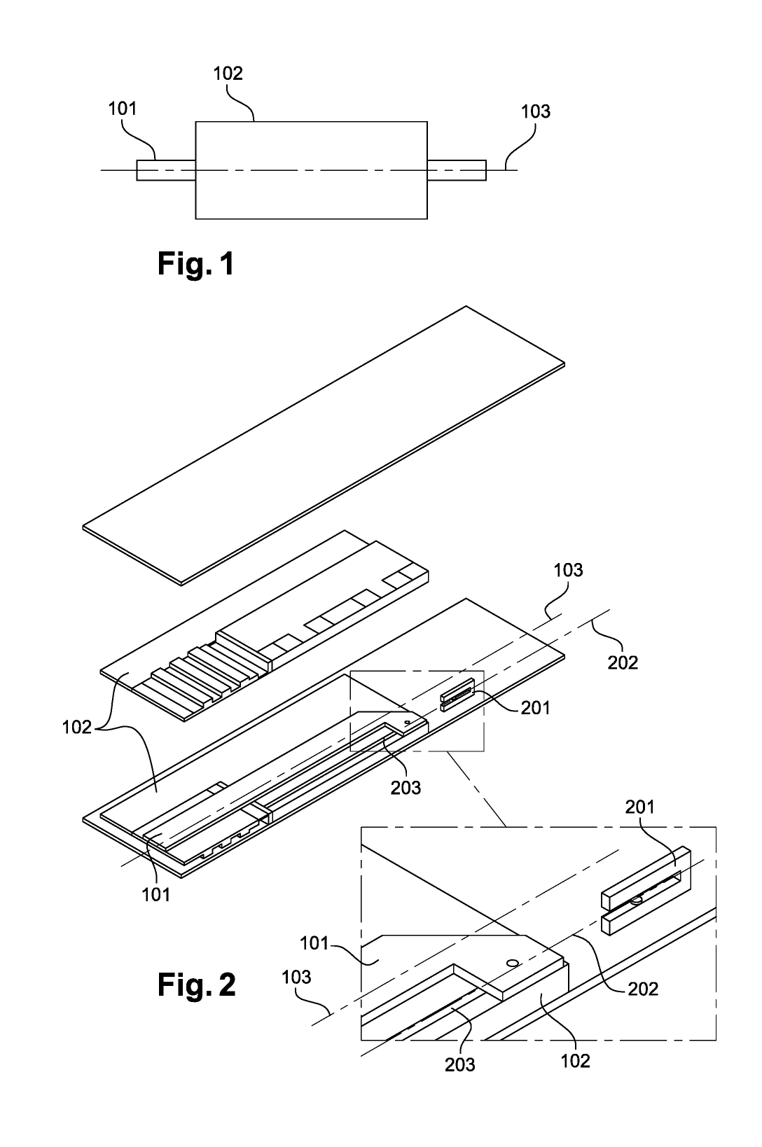

The FIG. 1 presents an embodiment of the apparatus of the present subject matter. The apparatus forms a phase-shifter. The apparatus comprises a strip line 101 and a moving dielectric part 102. The moving dielectric part 102 surrounds the strip line 101 and is adapted to move only along a longitudinal axis 103 of the strip line. The stripe line is also known as propagation line. Wherein the size of the area of the strip line 101 surrounded by the moving dielectric part 102 is modified when the moving dielectric part 102 moves along the longitudinal axis 103.

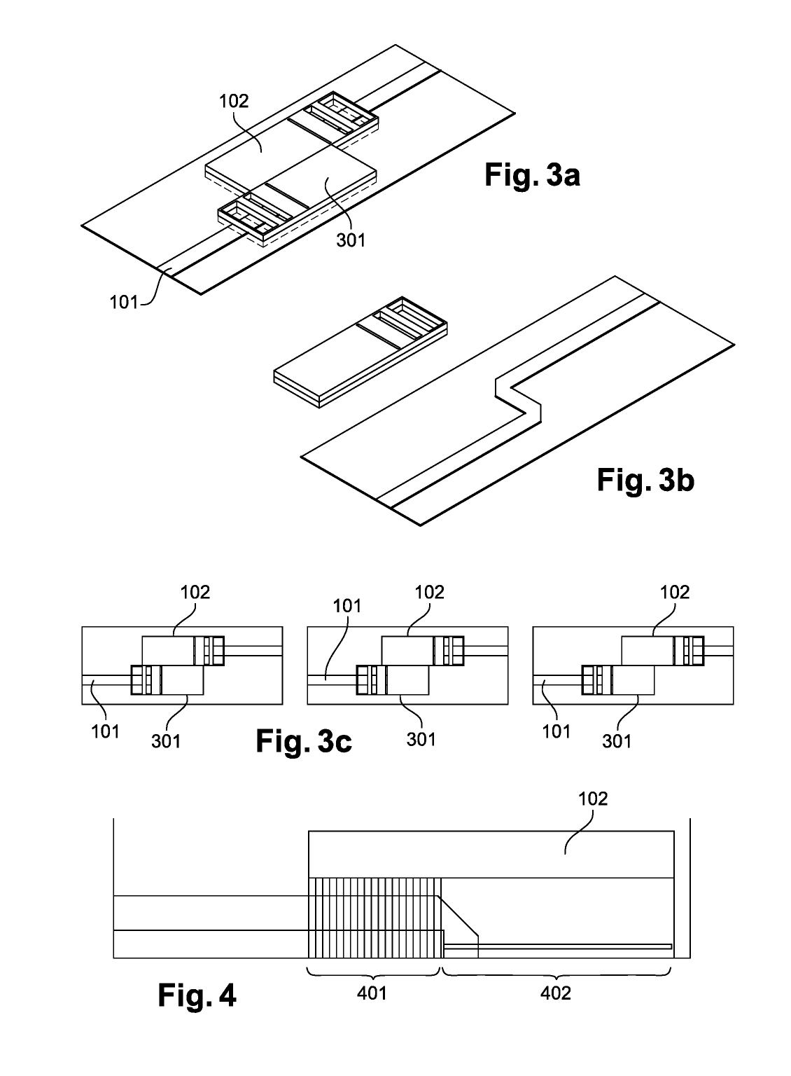

In order to have the size of the area of the strip line 101, surrounded by the moving dielectric part 102, modified, when the moving dielectric part 102 moves along a longitudinal axis 103, the strip line 101 can have an L (see enlarged view of the FIG. 2) shape or a triangular shape.

This embodiment allows a “perfect” mechanical position of phase sifter versus the propagation line. So using this embodiment allows the phase-shifter to work at high frequency bands such as 3.5 GHz and over.

In an embodiment the apparatus also comprises guiding means. These guiding means are configured to guide the movement of the moving dielectric part 102 along the longitudinal axis 103 of the strip line 101.

The FIG. 2 presents another embodiment of the phase shifter. In this embodiment the guiding means are constituted of a key 201 placed along an axis parallel 202 to the longitudinal axis 103 of the strip line 103 and a keyway 203 realize within the moving dielectric part 102. The key 201 is configured to be fixed with respect to the strip line 103 and to cooperate with the keyway 203. The key 201 is also configured to allow the movement of the moving dielectric part 102 only along the longitudinal axis 103 of the strip line 101. The keyway is also known a slot.

In an embodiment the key 201 is fixed to the strip line 101 or the key 201 and the strip line 101 are both fixed to a ground plate.

In an embodiment the key 201 is a clip made for example of plastic dielectric.

In an embodiment the key is inserted, should have a length at least equal to the width of the strip line, and made from the same dielectric material than the phase shifter device. This avoids any modification of the strip line area where the key is inserted. In this embodiment a slot (or keyway) is placed all along the phase shifter at the corresponding position of the clip, in order to be able to slide it along the longitudinal axe. Within this embodiment, there is no modification of the general radio frequency construction and so the phase shifter behavior isn't modified compared to phase-shifter of the state of the art.

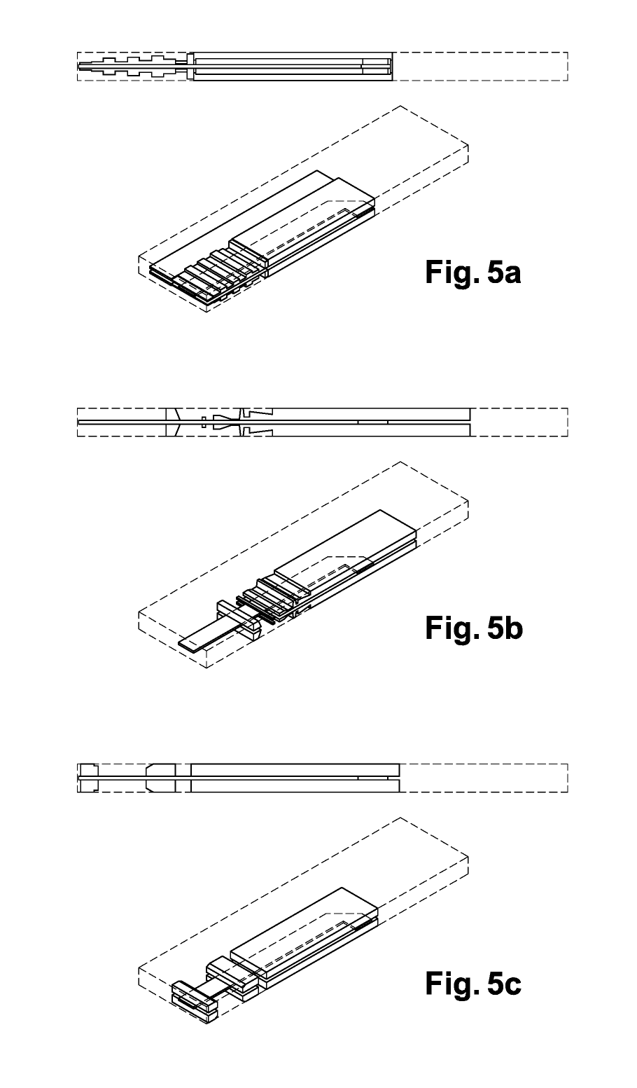

The FIG. 3-a presents another embodiment of the phase-shifter. In this embodiment the guiding means are constituted of a second dielectric part 301 configured to be still with respect to the strip line and arranged to allow the movement of the moving dielectric part 102 only along a longitudinal axis 103 of the strip line 101.

FIG. 3-b present the size of the different elements of the phase shifter according to one embodiment. This phase-shifter is capable of convenient radio frequency performances from 3.4 GHz up to 4.2 GHz. This phase shifter is realized using a suspended stripline mode. A PCB here a single side ROGERS RT Duroid 5870 of 0.254 mm thick, 0.35 microns of copper is placed at the center of two metallic ground planes (not represented here) i.e. one at the top and one at the bottom, spaced here of 7.2 mm. On each sides of this PCB are placed one fix dielectric Phase Shifter (one top+one bottom), and one moveable dielectric Phase Shifter (one top+one bottom)—made here of a dielectric material of a dielectric constant of 4.

The FIG. 3-c depicted top views of the FIG. 3-a Phase Shifter topology sliding 30 mm in an axial movement (min, avg, max). One of the Phase shifter is kept fixed and the second one s translating.

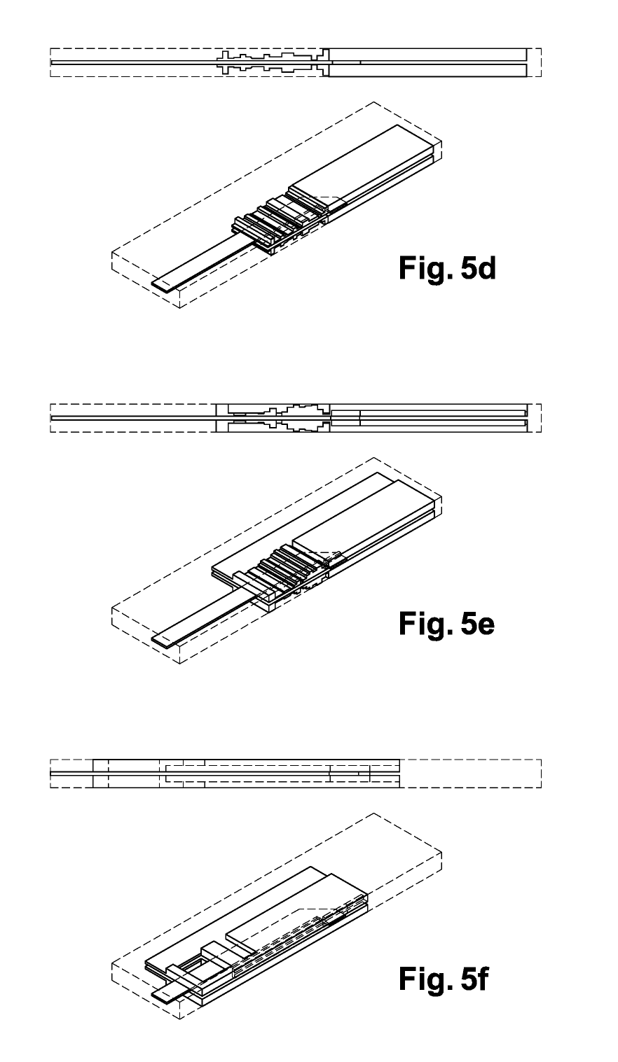

The FIG. 4 presents an embodiment of the phase shifter in which the moving dielectric part 102 also comprises an impedance transformation part 401 and a fixed impedance part 402. In other words within this embodiment the moving dielectric part is made of three main areas. The first area is the impedance transformation part. The second area is relative to a fixed impedance area. Considering that the transmission line is continuously displacing below the area three, a modification made on area three at a certain position will not have or have low influence at another position. So, it can be created some variations on the dielectric part, as thicknesses variations, all along the area three in order to create some “fine tunings” of the input and output impedances.

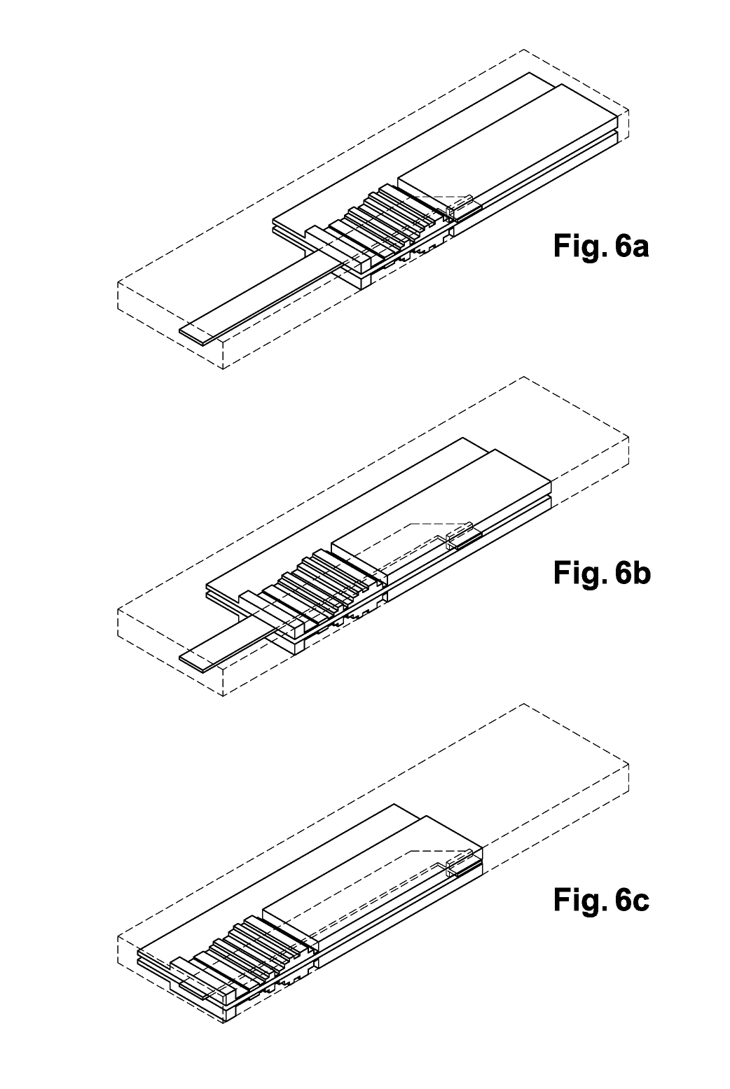

The FIGS. 5-a to 5-f present examples of other phase shifters impedance transformer designs that will permit to achieve the same kind of performances. The phase shifter of the present subject matter can be used with different impedance transformer section.

In an embodiment the moving dielectric part 102 are constituted of two identical parts the first part placed over the strip line and the second part placed under the strip line.

In another embodiment the stripe line 101 is made by etching a metal layer of a printed circuit board.

An embodiment of the present subject matter is an antenna that comprises the apparatus of any of the preceding embodiments. The phase-shifter is placed in a housing of which one of the faces is formed by a chassis of the antenna.

In other words the different embodiments of the phase shifter permit to guaranty the “perfect” mechanical position of the moving dielectric part versus the propagation line. Indeed the extra parts (for example the key and keyway) inserted in the different elements of the phase-shifter, and are cause of increasing the mechanical tolerances between the dielectric phase shifters and the propagation line.

In an embodiment and on order to avoid this, and be sure that the phase shifter mechanical positioning is directly referenced to the propagation line, a small part, called “guide” or key. This key or “guide can for example be inserted directly onto the line.

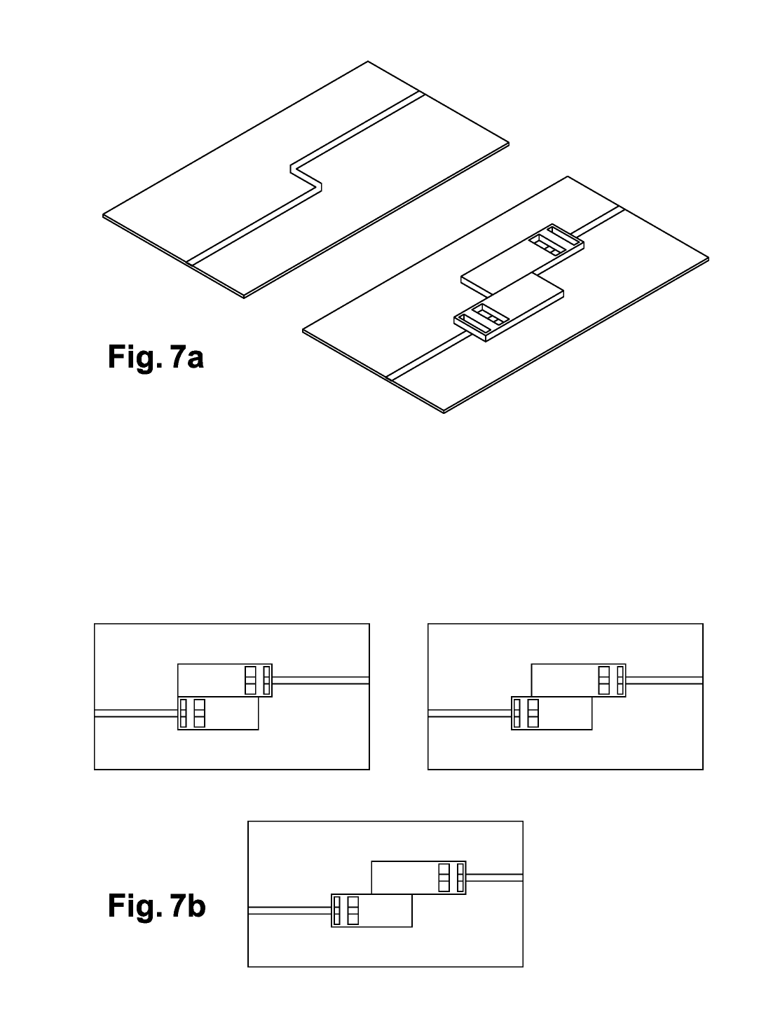

FIGS. 6-a, 6-b and 6-c presents respectively the phase shifter at min, mid and max mechanical positions.

The FIGS. 7-a and 7-b present another embodiment of the phase shifter. This phase shifter is made with a microstrip. All the phase shifters of the previous embodiments can work with microstrip instead of stripline or suspended stripline. Within this embodiment a Taconic TLX PCB (0.787 mm thick) is used to realize a 50 Ohms microstrip line (copper trace width is about 2.25 mm for 35 microns thick). Over this PCB is placed two 2 mm thick dielectric elements, made of a material with a dielectric constant of about 10.

One other object of the present subject matter is an antenna comprising one of the phase-shifter previously described. This phase-shifter is placed in a housing of which one of the faces is formed by a chassis of the antenna.

1. An apparatus, comprising:
a strip line; and
a moving dielectric part, the moving dielectric part surrounding the strip line and being adapted to move only along a longitudinal axis of the strip line,
wherein the apparatus comprises a phase shifter, and wherein a size of an area of the strip line surrounded by the moving dielectric part being modified when the moving dielectric part moves along the longitudinal axis.

2. The apparatus according to the claim 1, further comprising:
a guide configured to guide a movement of the moving dielectric part along the longitudinal axis of the strip line.

3. The apparatus according to the claim 2, wherein:
the guide comprises a key disposed along an axis parallel to the longitudinal axis of the strip line and a keyway located within the moving dielectric part, and
the key is configured to be fixed with respect to the strip line and to cooperate with the keyway and to allow the movement of the moving dielectric part only along the longitudinal axis of the strip line.

4. The apparatus according to the claim 3, wherein:
the key is fixed to the strip line, or
the key and the strip line are both fixed to a ground plate.

5. The apparatus according to the claim 3, wherein:
the key is a clip comprising a plastic dielectric.

6. The apparatus according to the claim 2, wherein:
the guide comprises a further dielectric part configured to be still with respect to the strip line and configured to allow movement of the moving dielectric part only along the longitudinal axis of the strip line.

7. The apparatus according to claim 1, wherein:
the moving dielectric part also comprises an impedance transformation part and a fixed impedance part.

8. The apparatus according to claim 1, wherein:
the moving dielectric part comprises two identical parts; a first part placed over the strip line, and a second part placed under the strip line.

9. The apparatus according to claim 1, wherein:
the strip line is made by etching a metal layer of a printed circuit board.

10. The apparatus according to claim 1, wherein the strip line has an L shape or a triangular shape.

11. An antenna comprising the apparatus of claim 1, wherein the apparatus is disposed in a housing having a face comprising a chassis of the antenna.

12. A method of forming a phase shifter, said method comprising:
providing a strip line, said strip line having a longitudinal axis;
providing a moving dielectric part, said moving dielectric part being movable relative to the strip line along the longitudinal axis, said moving dielectric part being formed to surround the strip line; and
wherein a size of an area of the strip line that is surrounded by the moving dielectric part changes when the moving dielectric part moves along the longitudinal axis.

13. The method according to claim 12, further comprising providing a guide, said guide being configured to guide a movement of the moving dielectric part along the longitudinal axis of the strip line.

14. The method according to claim 13, wherein the guide is provided in the form of a key disposed along an axis parallel to the longitudinal axis of the strip line, and a keyway located within the moving dielectric part, wherein the key is configured to be fixed with respect to the strip line and to cooperate with the keyway and to allow movement of the moving dielectric part only along the longitudinal axis of the strip line.

15. The method according to claim 14, further comprising:
fixing the key to the strip line, or
fixing the key and the strip line to a ground plate.

16. The method according to claim 14, wherein the key comprises a clip formed of a plastic dielectric.

17. The method according to claim 13, wherein the guide is formed of a further dielectric part and configured to be still with respect to the strip line, and configured to allow movement of the moving dielectric part only along the longitudinal axis of the strip line.

18. The method according to claim 12, wherein the moving dielectric part comprises an impedance transformation part and a fixed impedance part.

19. The method according to claim 12, wherein the moving dielectric part is formed of two identical parts, wherein a first part is placed over the strip line and a second part is placed under the strip line.

20. The method according to claim 12, wherein the strip line is formed by etching a metal layer of a printed circuit board.
